(19) United States
(12) Patent Application Publication
(10) Pub. No.: US 2006/0172761 A1
(43) Pub. Date: Aug. 3, 2006

(54) Mobile phone having dual outer liquid crystal displays

(75) Inventors: Jong-Hyeok Im, Suwon-si (KR); Hun-Woong Yang, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/245,231

(22) Filed: Oct. 6, 2005

(30) Foreign Application Priority Data
Feb. 3, 2005 (KR) 9905/2005

(51) Int. Cl. H04M 1/00

(52) U.S. Cl. 455/550.1

(57) ABSTRACT

Disclosed is a mobile phone in which a main liquid crystal display and a sub-liquid crystal display are disposed parallel to each other in side by side relation. The folder-type mobile phone has dual outer liquid crystal displays and includes a body housing and a folder which can be opened from the body housing. The mobile phone includes a main liquid crystal display provided in the lengthwise direction of the body housing, a sub-liquid crystal display provided in the lengthwise direction of the folder, and a hinge unit rotatably connecting the folder to the body housing. The hinge unit disposes the main liquid crystal display and the sub-liquid crystal display to be parallel to each other in side by side relation by rotating the folder about a hinge axis. Thus, the folder is situated remote from the body housing in the lengthwise direction of the body housing.

### PRIORITY

This application claims priority to an application entitled “MOBILE PHONE HAVING DUAL OUTER LIQUID CRYSTAL DISPLAYS” filed in the Korean Industrial Property Office on Feb. 3, 2005 and assigned Serial No. 2005-9905, the contents of which are herein incorporated by reference.

### BACKGROUND OF THE INVENTION

1. Field of the Invention

The present invention relates to a mobile phone having dual outer liquid crystal displays, and more particularly to a mobile phone which has a main liquid crystal display and a sub-liquid crystal display disposed parallel to each other.

2. Description of the Related Art

In general, mobile communication devices are devices with which users can perform radio communications with partners while carrying the device. The mobile communication devices include an Hand-Held Phone (HHP), a CT-2 cellular phone, a digital phone, a Personal Communications Services (PCS) phone, and a Personal Digital Assistance (PDA), and are sorted into various types based on their shapes.

A bar-type mobile phone includes a body, an antenna unit installed at an upper end of the body, an earpiece having a speaker on a lower side of the antenna unit, and a liquid crystal display (LCD) installed on a lower side of the earpiece to perform display function, and a key pad located on a lower side of the liquid crystal display and having a plurality of number keys and function keys, and a microphone unit located on a lower side of the key pad.

As shown in FIG. 1, a folder-type mobile phone 1 is used to enlarge the screen of a display without increasing the size of the phone 1. However, the folder-type mobile phone 1 has a disadvantage in that a user cannot see the contents of the display when a folder 3 of the phone 1 is closed to the body housing 2.

To solve the problem, as shown in FIG. 2, a dual liquid crystal display folder which provides a main liquid crystal display 3b and a separate outer liquid crystal display 3a on the inner and outer sides of the folder 3, respectively, has been developed.

In the dual liquid crystal display folder 3, the main liquid crystal display 3b and the outer liquid crystal display 3a showing the reception of signals and the status of the mobile phone are located on the inner and outer side of the folder 3, respectively.

Even when the folder 3 is closed, various information such as the current time, the strength of the receiving electric wave, and the residual amount of a battery can be confirmed through the outer liquid crystal display 3a.

However, according to the conventional dual liquid crystal display folder, the small-sized outer liquid crystal display is mounted on the outside of the folder and the large-sized liquid crystal display is mounted on the inner side of the folder. Therefore, when the folder is closed, only the small-sized outer liquid crystal display can be used and it is inconvenient to see various information and images on the small-sized outer liquid crystal display. Further, the large-sized liquid crystal display located on the inner side of the folder should be used to see the complete information and images.

### SUMMARY OF THE INVENTION

Accordingly, the present invention has been made to solve the above described problems, and an object of the present invention is to provide a mobile phone having dual outer liquid crystal displays, in which a main liquid crystal display and a sub-liquid crystal display are disposed parallel to and aligned with each other, thereby enhancing the display function of the mobile phone.

In order to accomplish this object, a folder-type mobile phone having dual outer liquid crystal displays includes a body housing and a folder which can be opened from the body housing. The body housing and folder include a main liquid crystal display provided in the lengthwise direction of the body housing, a sub-liquid crystal display provided in the lengthwise direction of the folder, and a hinge unit rotatably connecting the folder to the body housing. The hinge unit disposes the main liquid crystal display and the sub-liquid crystal display parallel to each other in side by side relation by rotating the folder about a hinge axis. Thus, the folder becomes remote from the body housing in the lengthwise direction of the body housing.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view of a conventional folder-type mobile phone when the folder is opened;

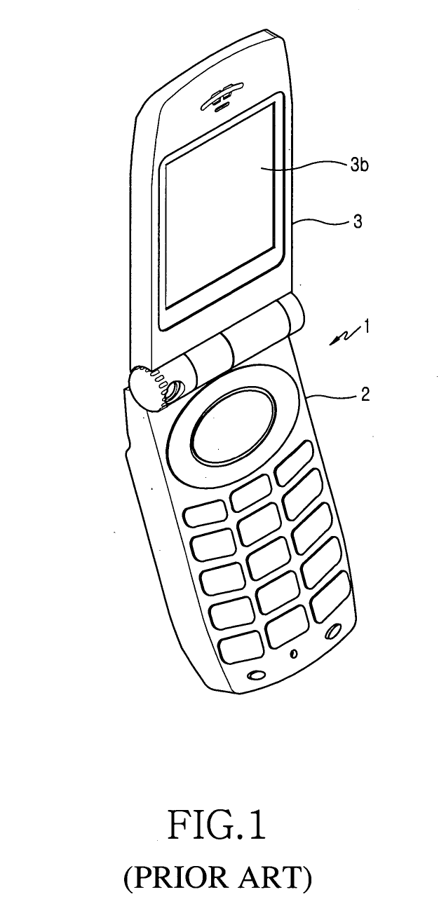

FIG. 2 is a perspective view of a conventional folder-type mobile phone when the folder is closed;

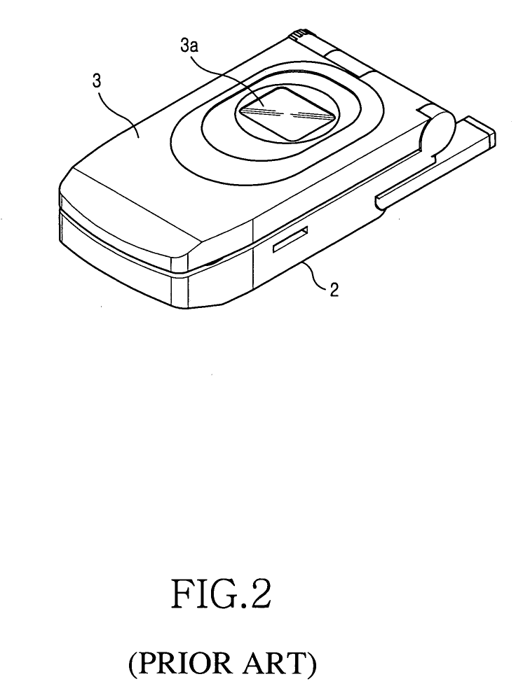

FIG. 3 is a perspective view illustrating a front face of a folder of a mobile phone having dual outer liquid crystal displays according to a preferred embodiment of the present invention when the folder is closed;

FIG. 4 is a perspective view illustrating a rear face of a body housing of a mobile phone having dual outer liquid crystal displays according to a preferred embodiment of the present invention when the folder is closed;

FIG. 5 is a perspective view illustrating a mobile phone having dual outer liquid crystal displays according to a preferred embodiment of the present invention when folder is opened; and

FIG. 6 is a plan view illustrating a mobile phone having dual outer liquid crystal displays according to a preferred embodiment of the present invention when folder is opened.

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein is omitted to avoid making the subject matter of the present invention unclear.

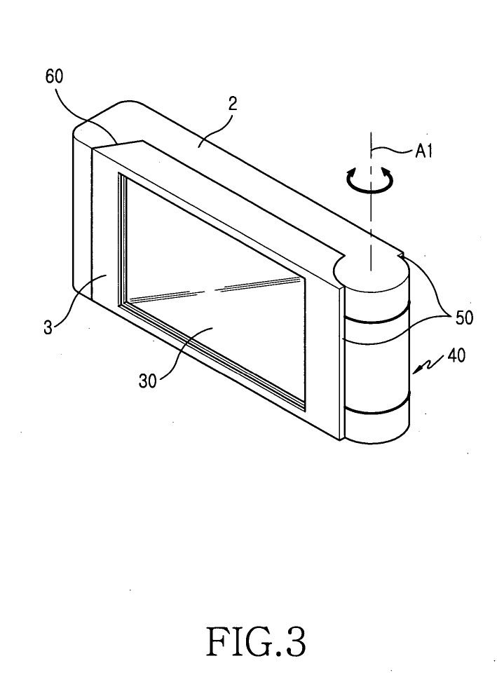

As shown in FIGS. 3 to 5, a mobile phone having dual outer liquid crystal displays includes a main liquid crystal display 20, a sub-liquid crystal display 30, and a hinge unit 40. The main liquid crystal display 20 is provided in the lengthwise direction of the body housing 2 to be disposed parallel to the sub-liquid crystal display 30 side by side. The sub-liquid crystal display 30 is provided in the lengthwise direction of the folder 3 to be disposed parallel to the main liquid crystal display 20 in side by side relation. The hinge unit 40 rotatably connects the folder 3 to the body housing 2. The hinge unit 40 is provided between the folder 3 and the body housing 2 to dispose the main liquid crystal display 20 and the sub-liquid crystal display 30 parallel to each other by rotating the folder 3 about a hinge axis A1. Thus, the folder 3 is situated remote from the body housing 2 in the lengthwise direction of the body housing 2.

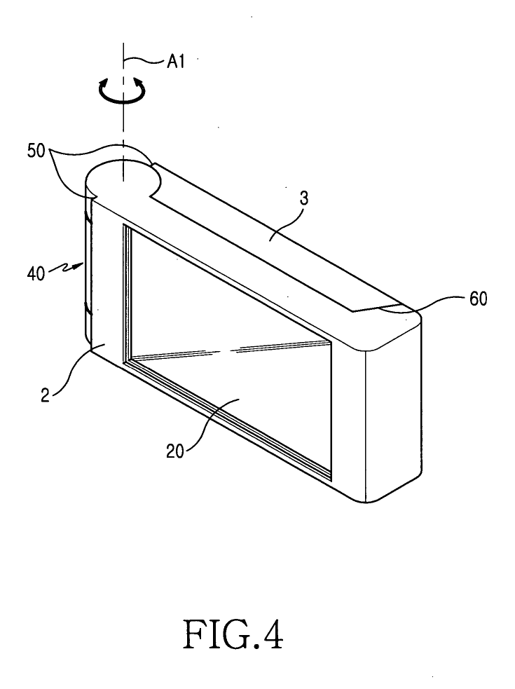

As shown in FIG. 4, the main liquid crystal display 20 is provided on a rear face of the body housing 2 so that the sub-liquid crystal display 30 and the main liquid crystal display 20 of the body housing 2 are located in side by side relation by rotating the folder 3.

As shown in FIG. 3, the sub-liquid crystal display 30 is provided on a front face of the folder 3 so that the main liquid crystal display 20 of the body housing 2 and the sub-liquid crystal display 30 of the folder 3 are located in side by side relation.

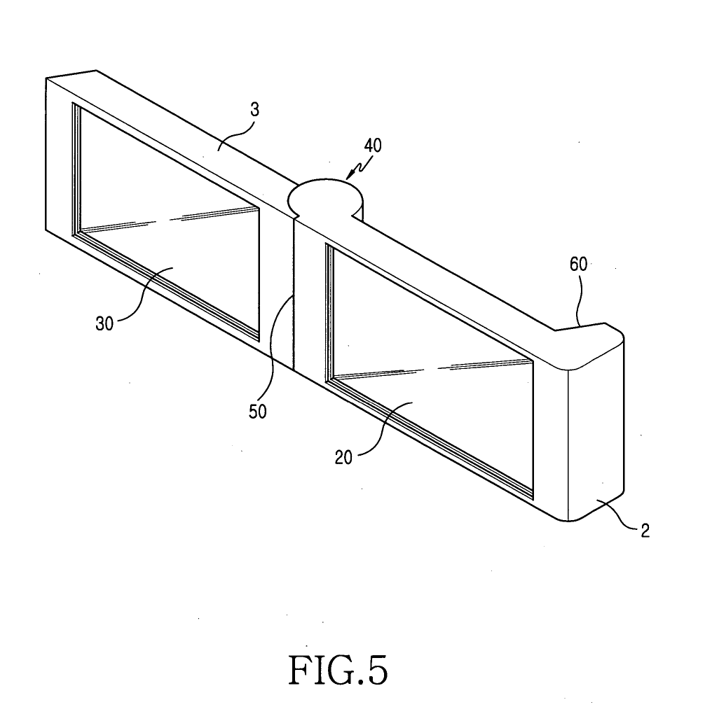

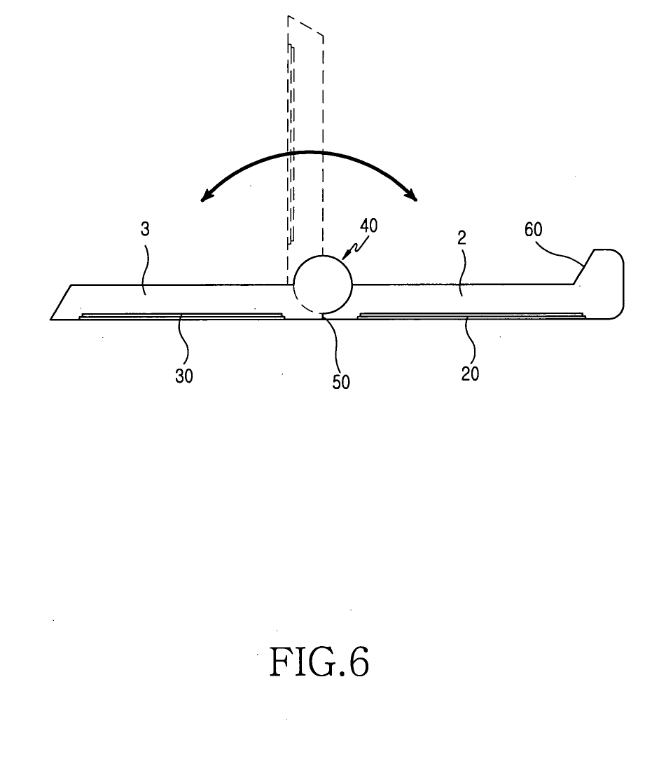

As shown in FIGS. 5 and 6, the hinge unit 40 rotates the folder up to 180 degrees with respect to the body housing 2. A first stopper means 50 is provided at an end of each of the body housing 2 and the folder 3 to stop the rotation of the folder 3. Thus, the folder 3 is rotatable about a hinge axis A1 with respect to the body housing 2 up to 180 degrees to be situated remote from the body housing 2.

As shown in FIG. 3, a second stopper means 60 is provided at the other end of each of the body housing 2 and the folder 3 to stop the rotation of the folder 3. Thus, the folder 3 rotates about the hinge axis A1 and then is stopped near the body housing 2.

Hereinafter, the operation of the mobile phone having dual outer liquid crystal displays according to the preferred embodiment of the present invention will be described in detail.

As shown in FIG. 6, the folder 3 rotates about the hinge axis A1 in the lengthwise direction of the housing 2 to become remote from the body housing 2. Then, the folder rotates up to 180 degrees with respect to the body housing 2.

As shown in FIG. 5, the body housing 2 and the folder 3 are positioned in side by side relation, and at the same time the main liquid crystal display 20 of the body housing 2 and the sub-liquid crystal display 30 of the folder 3 are disposed parallel to each other. Therefore, the user can see a wide screen by operating a TV mode and a moving image mode provided to the telephone and using two liquid crystal displays 20 and 30.

As shown in FIG. 6, the first stopper means 50 is provided at one end of each of the body housing 2 and the folder 3 to stop the rotation of the folder 3 so that the folder 3 rotates about a hinge axis A1 up to 180 degrees with respect to the body housing 2. When the folder 3 rotates, one end of the folder 3 and one end of the body housing 2 contact each other and the rotation of the folder 3 is stopped at about 180 degrees with respect to the body housing 2.

As shown in FIGS. 3 and 4, when the folder 3 rotates about the hinge axis A1 to be near the body housing 2, the rotation of the folder 3 stops at a position at which the body housing 2 and the folder 3 is positioned opposite to each other by the second stopper means 60 located at the other end of each of the folder 3 and the body housing 2.

As above described, according to the present invention, since the main liquid crystal display and the sub-liquid crystal display are displayed simultaneously, the display function of the telephone is improved and the use of the telephone is enhanced.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A folder-type mobile phone having dual outer liquid crystal displays, comprising:
a body housing;
a folder being opened from the body housing;
a main liquid crystal display provided in the lengthwise direction of the body housing;
a sub-liquid crystal display provided in the lengthwise direction of the folder; and
a hinge unit rotatably connecting the folder to the body housing, the hinge unit disposing the main liquid crystal display and the sub-liquid crystal display to be positioned parallel to each other in side by side relation by rotating the folder about a hinge axis of the hinge unit so that the folder becomes remote from the body housing in the lengthwise direction of the body housing.

2. A folder-type mobile phone according to claim 1, wherein the main liquid crystal display is mounted on a rear face of the body housing.

3. A folder-type mobile phone according to claim 1, wherein the sub-liquid crystal display is mounted on a front face of the folder.

4. A folder-type mobile phone according to claim 1, wherein the hinge unit rotates the folder to be located about 180 degrees with respect to the body housing.

5. A folder-type mobile phone according to claim 1, wherein the main liquid crystal display and the sub-liquid crystal display are displayed in side by side relation simultaneously.

6. A folder-type mobile phone according to claim 1, further comprising a first stopper means being situated at an end of each of the body housing and the folder to stop the rotation of the folder so that the folder rotates about a hinge axis up to 180 degrees with respect to the body housing to be situated remote from the body housing, and a second stopper means being situated at the other end of each of the body housing and the folder to stop the folder so that the folder rotates about the hinge axis and then is stopped near the body housing.

7. A folder-type mobile phone having a dual liquid crystal display, comprising:
a first housing having a main liquid crystal display;
a second housing having a sub-liquid crystal display being opened from the first housing; and
a hinge unit rotatably connecting the second housing to the first housing, the hinge unit disposing the main liquid crystal display and the sub-liquid crystal display to be positioned parallel to each other in side by side relation by rotating the second housing about a hinge axis so that the second housing becomes remote from the first housing in the lengthwise direction of the first housing and displaying the main liquid crystal display and the sub-liquid crystal display.
